(19) United States
(12) Patent Application Publication
(10) Pub. No.: US 2007/0254643 A1
(43) Pub. Date: Nov. 1, 2007

(54) Method and apparatus for measuring the error rate of a communication device

(76) Inventors: Francisco Garcia, Dunfermline (GB); Robert Gardner, Glasgow (GB); Colin McGilp, Edinburgh (GB)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/450,000

(22) Filed: Jun. 9, 2006

(30) Foreign Application Priority Data
Apr. 28, 2006 (GB) 06 08 471.9

(51) Int. Cl. H04Q 7/20

(52) U.S. Cl. 455/423

(57) ABSTRACT

An apparatus and method for measuring the error rate of a wireless device, such as a WLAN card, comprising a signal generator, a signal receiver and the device under test configured to transmit and receive frames. The signal generator transmits frames to the device under test, which sends an acknowledgement if a frame has been validly received. A controller counts valid acknowledgements received and pseudo-valid acknowledgements sent by the device (up to a maximum of one per transmitted frame). The pseudo-valid acknowledgements may be corrupted acknowledgements received by the signal receiver or signals resembling an acknowledgement detected during a time when an acknowledgement is expected. Thus a frame error rate is computed based on the total number of valid and pseudo-valid acknowledgements compared to the total number of frames sent.

This invention relates to a method and apparatus for measuring the error rate of a communication device, specifically, but not exclusively, for measuring the frame error rate of a wireless communication device.

### BACKGROUND

In a modern telecommunications network, comprising a number of nodes, such as computers, routers, switches or other devices, data packets are transmitted across a network from one node to another. Sometimes the packet is sent in a frame over the wireless interface (radio frequency interface) between the nodes. A packet sent from one node to another is not always received by the destination accurately enough and is then considered “lost”. This problem is particularly significant in wireless networks. For example, a wireless medium is especially susceptible to noise (electromagnetic interference) generated by equipment located nearby.

Such wireless networks are governed by standards, which govern, among other things, the length and format of a packet, the length and format of a frame, the signalling between each node, the type of interface used etc. One such standard is the IEEE 802.11 standard, which is an ISO standard, more specifically “International Standard ISO/IEC 8802-11: 1999(E), Wireless LAN Medium Access Control (MAC) and Physical Layer (PHY) specifications 1999”.

In general, wireless networks include two or more wireless devices (stations) capable of communicating with one another. This communication may or may not occur via a wireless Access Point (AP). A wireless AP will normally allow access from a wireless device to another network, such as the Internet. A wireless device is often a portable computer with a Wireless Local Area Network (W-LAN) card that has been installed, or that is already integrated. W-LAN cards are provided by a number of different manufacturers and usually comprise a wireless interface, which will include a transmit and receive antenna, as well as a combination of hardware and software that control the operation of the card.

In common with other means of wireless communication, transmissions according to the IEEE 802.11 standard are subject to interference which may cause bit-errors. The probability of obtaining a bit-error is a function of various parameters such as: received noise power vs. received signal power (signal to noise ratio); “time of flight”, which is related to the distance between the devices communicating and therefore is the time it takes for the frame to travel that distance; physical layer coding/modulation methods; and antenna design.

Bit-errors are often identified by comparing a frame check sequence (FCS) transmitted in a frame with a frame check sequence computed at the receiving node. If the packet passes the FCS check, then the receiving node transmits an acknowledgement (ACK) to the sending node signifying successful reception of the immediately preceding frame. If a frame fails this check then a frame error is said to have occurred and no acknowledgement is sent. Owing to the lack of acknowledgement, the sending station then attempts to retransmit the frame one or more times, if necessary. However, because bit errors are often dealt with by resending the packet, bit errors can slow down the operation of a network and are therefore highly undesirable.

The Frame Error Rate (FER), which is also often referred to as the packet error rate (PER), is the ratio of transmitted frames to received acknowledgements. The measurement of FER (PER) is of interest to manufacturers of wireless devices as it enables different devices to be compared to each other in order to evaluate their relative performance, especially relating to receiver sensitivity, under varying conditions. Such variables might include but are not limited to the parameters mentioned above, such as: ambient noise power; signal power; time of flight; physical layer coding/modulation methods; as well as antenna design etc.

FER is also of interest to network operators and network service providers since it, in turn, can directly affect network metrics such as packet loss, packet latency, packet jitter and throughput. An apparatus and method for the measurement of PER in a wireless LAN network is disclosed in US Patent Application US2004-076138, which is herein incorporated by reference.

The solution disclosed in US2004-076138 consists of an anechoic chamber in which a device under test (DUT), such as a W-LAN card, is placed for testing to determine its PER in the face of varying levels of noise. Also inside the chamber is a ‘controller’ which includes a ‘known WLAN card’ and the transmitting antenna of a signal generator. The controller is used to (a) get the DUT into the correct authenticated and associated state in preparation for the packet error rate tests and (b) to receive and count acknowledgements transmitted by the DUT. The signal generator is used to create a signal that mimics multiple W-LAN data frames on a particular channel which can be received by the DUT. The signal generator is also able to simultaneously inject white noise of a controllable level into the chamber to simulate interference/noise as might be experienced in a real-life W-LAN operating environment. By comparing the number of packets sent by the signal generator with the number of acknowledgements received by the controller WLAN interface, a measure for the packet error rate can be obtained.

However, the technique disclosed in US2004-076138 may sometimes fail to properly achieve its stated aims because, when no acknowledgement is received after the transmission of a packet, the measurement system as described, is not able to distinguish between the DUT failing to successfully receive a data packet and the ‘controller’ failing to successfully receive an acknowledgement.

In particular, the described method could have difficulties depending on the quality of the RF interface used in the controller. PER testing is intended to test the quality of the DUT's receiver, sometimes referred to as “receiver sensitivity testing”. Separate modulation accuracy and spectral measurements are typically used to characterise a DUT's transmitter. To perform these, the tester requires a receiver capable of parametric measurements.

Often receiver sensitivity testing is performed at a low transmit power from the tester and the ACKs come back at high power, making the uplink (for the ACKs) more robust, (assuming equal quality receivers in both the DUT and the tester). However, if the DUT has a poor quality transmitter or the tester has a poor quality receiver then the ability to truly measure the DUT's receiver PER would be questionable.

Therefore, the methodology as disclosed in US2004-076138 means that it may not be possible to ascertain whether a particular PER performance is limited by the DUT, or by the W-LAN controller interface.

### SUMMARY OF THE DISCLOSED EMBODIMENTS

According to one aspect of this invention there is provided a method for measuring the error rate of a communication device, the method comprising configuring a signal generator and the communication device to communicate, transmitting a signal frame from the signal generator, sending an acknowledgement from the device under test if the signal frame is correctly received by the device under test, determining whether a valid or pseudo-valid acknowledgment has been sent by the communication device, counting the number of valid and pseudo-valid acknowledgements, and computing a frame error rate based on the total number of valid and pseudo-valid acknowledgements compared to the total number of signal frames transmitted.

According to second aspect of the invention, there is provided a system for measuring the error rate of a communication device, the system comprising a signal generator for transmitting a signal frame to the communication device, a controller coupled to said signal generator for controlling the signal generator, wherein said controller determines whether a valid or pseudo-valid acknowledgment has been sent by the communication device, and wherein said controller counts the number of valid and pseudo-valid acknowledgements and computes a frame error rate based on the total number of valid and pseudo-valid acknowledgements compared to the total number of signal frames transmitted.

### BRIEF DESCRIPTION OF THE DRAWINGS

A method and apparatus in accordance with this invention, for measuring the error rate of a communication device, will now be described, by way of example, with reference to the accompanying drawings, in which:

FIG. 1 is a diagram showing the apparatus used to perform an error rate measurement of a wireless interface, according to one embodiment of the present invention; and

FIG. 2 is a flow chart showing a method of operation of the apparatus of FIG. 1.

### DETAILED DESCRIPTION

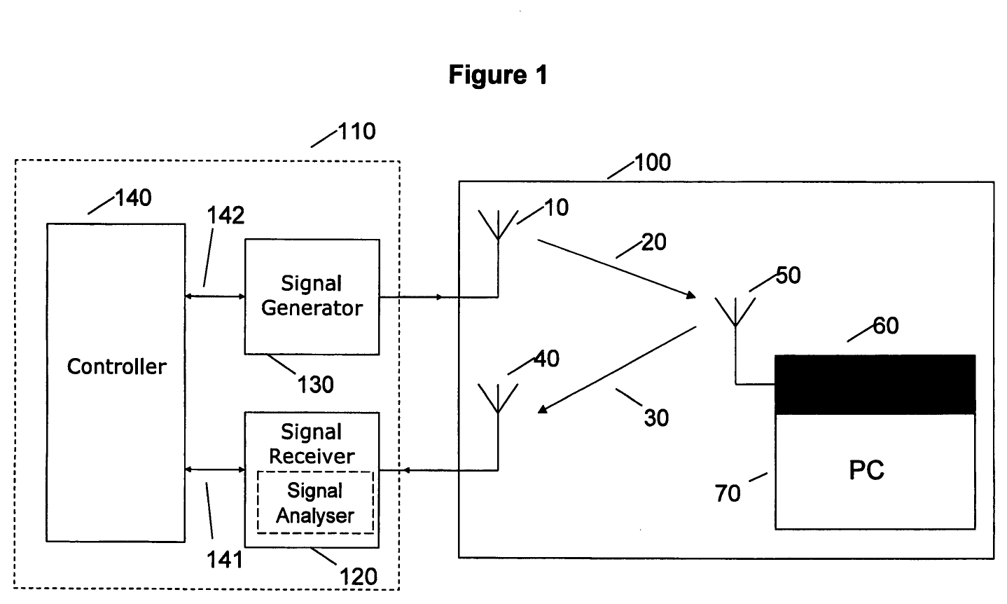

FIG. 1 is a diagram showing the apparatus according to one embodiment of the present invention used to perform an error rate measurement of a wireless device. There is provided an anechoic chamber or other appropriate RF-shielded test fixture 100, which houses a DUT 60, which may be, for example, an IEEE 802.11 W-LAN card. The DUT 60 is plugged into, integrated into or otherwise attached to a client PC 70, or other suitable device. The client PC 70 with the DUT 60 installed is placed inside the anechoic chamber 100 or other RF-shielded test fixture for testing to determine the W-LAN card's FER in the face of varying levels of noise. Anechoic chambers 100 are well known in the art and are lined with materials that absorb radio waves over a large range of frequencies. Therefore external electromagnetic interference is excluded, as well as internal reflections of internally generated radio frequency (RF) energy, thus preventing multi-path radiation effects.

Located outside the anechoic chamber or other appropriate RF-shielded test fixture 100 are a signal generator 130 and a signal receiver 120. The signal generator 130 generates frames in the appropriate protocol for the particular DUT, for example, according to the IEEE 802.11 standard, and the signal receiver 120 can receive, and potentially decode, the frames according top the chosen protocol. The signal generator 130 is also capable of simultaneously transmitting the frames and ‘white noise’, both of which may be transmitted at variable signal power. The functions of signal generator 130 and signal receiver 120 may be provided by two separate devices or a single device.

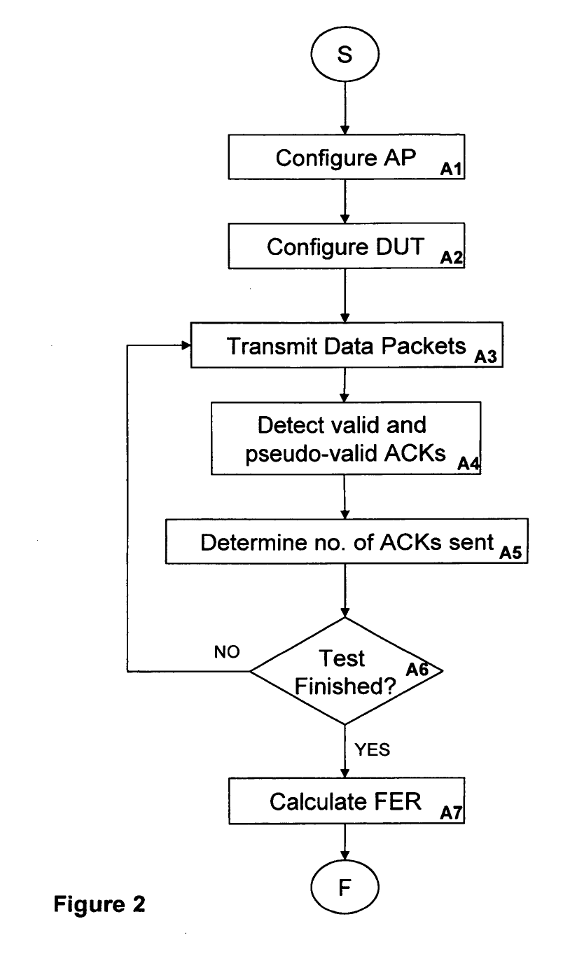

A controller 140 is coupled to the signal generator 130 and the signal analyser 120, via two way links 141 and 142 and controls the signal generator 130 and the signal receiver 120 in order to perform the various aspects of the FER test procedure, as discussed in more detail with reference to FIG. 2.

It should also be clear to someone skilled in the art that the functions of the controller 140, the signal generator 130, and the signal receiver 120 may also be provided by a single piece of equipment and together may also act as an access point (AP) 110. An AP 110 is any entity that has “station” functionality, for example as defined by the IEEE 802.11 specification. An AP 110 may also provide access to other networks, such as the Internet, via the wireless medium for other associated stations (nodes).

The FER test is performed by transmitting valid data frames over a wireless “up” link 20 from a transmit antenna 10 located in the anechoic chamber or other appropriate RF-shielded test fixture 100. The frames have a particular length and “dummy” contents and are transmitted at an appropriate data rate from the signal generator 130 to the DUT 60, via the transmit antenna 10. The data frame is received by the DUT 60 and an ACK is sent back over a wireless “down” link 30 to a receive antenna 40 located in the anechoic chamber 100, if the data frame is validly received. The ACKs are coupled to the signal receiver 120, where it is determined whether they are valid or not. The number of ACKS is then counted to enable the FER to be calculated. The FER test is described in more detail with reference to the flow diagram of FIG. 2.

The signal receiver 120 may also include a signal analyser portion which may be used to analyse signals received from the receive antenna 40, which may be a high sensitivity receiving antenna. More particularly, the signal receiver 120 will determine whether an acknowledgement received at the receive antenna 40 is a valid acknowledgement. However, if it is not determined to be a valid acknowledgement, this does not necessarily mean that the frame was invalidly received by the device. It could be that the frame was invalidly received, in which case the device, quite, properly, did not transmit and ACK, or it could mean that the frame was received properly and the device did generate an ACK, but that the ACK was then corrupted or otherwise not properly determined to be a valid ACK by the signal receiver.

Thus, if the signal receiver does not determine that a valid ACK is received, the signal analyser portion determines whether an ACK was received, but that it was corrupted so that it was considered not to be valid, or whether no ACK was received at all. In this case, the signal analyser determined whether a signal was detected by the receive antenna during the time when an ACK from the device was to be expected. If such a signal was detected, the signal analyser tries to determine whether the signal resembles an ACK signal. For example, whether the signal is on the same channel as used for ACKs. The signal analyser could be a spectrum analyser to determine whether the detected signal resembles an ACK signal in its frequency characteristics, or it could be a logarithmic amplifier to determine whether the detected signal resembles an ACK signal in having an RF pulse, similar to that of an ACK signal.

It will, of course, be appreciated, that, since detection of a signal on the acknowledgement channel takes place, this could take the place of the signal receiver determining whether the received ACKs are valid, since this will be superfluous. In this way, each and every ACK signal transmitted by the DUT will be detected and counted, without the need for the signal receiver to decode the ACKs received to determine whether they are valid or corrupted.

All such corrupted ACKs or signals resembling ACKs may be considered as pseudo-valid ACKs in that they were validly sent by the device, even though they were not validly received by the signal receiver. Accordingly, both valid and pseudo-valid ACKs should be counted for the purposes of determining FER, although, of course, a maximum of one valid or pseudo-valid ACK should be counted for each transmitted frame.

It should be clear to someone skilled in the art that it is important to properly observe inter-frame spacing (IFS) and ACK lengths in order to ensure that there is sufficient time to allow transmission by the DUT 60 of an ACK. The DUT 60 could also be put into the correct state for testing by using a real AP 110. Once in the correct state, the AP 110 may be powered down and the FER may begin.

FIG. 2 is a flow chart showing a method of operation of the apparatus of FIG. 1. All the blocks of the flow chart are described following. The operations of the apparatus performing the FER test start at “Start” and finish at “Exit”. Where appropriate, features have been numbered with respect to FIG. 1.

As indicated in block A1, the controller 140 first needs to configure the signal generator 130 and signal receiver 120, into a state ready to perform tests. The exact way in which this is done of course, will depend on the particular equipment used.

As indicated in block A2, the DUT 60 will also need to be configured into a state in which the FER measurements can be made. The method of achieving this again depends heavily on the driver and associated software being used within the DUT 60 and client station 70. For example, in the case of IEEE 802.11, if it is not already, the DUT 60 needs to be configured into an “infrastructure” mode of operation in which the DUT 60 attempts to associate itself with an AP 110 and would normally communicate to a wireless network via the associated AP 110. In the case of IEEE 802.11, the DUT 60 also needs to be configured with a service set identifier (SSID) in accordance with the IEEE 802.11 specification.

Then the DUT 60 would begin transmitting “probe request” frames in an attempt to find a compatible AP 110. A probe request is a frame which contains the SSID of the DUT 60 and supported data rates. Upon receiving the probe request, the controller 140, via the signal generator 130 would respond by sending a probe response back to the DUT 60 to indicate the presence of an emulated AP 110. The controller 140 and the DUT 60 can then begin an “association/authentication” process. There are a variety of association techniques known by those skilled in the art and may be performed, for example, in accordance with the IEEE 802.11 specification. Once the DUT 60 associates/authenticates itself with the controller 140, the controller 140, in combination with the signal generator 130 and the signal receiver 120, are effectively emulating an AP 110.

Once the DUT 60 is configured and the association/authentication procedure is completed, the AP 110 and the DUT 60 can transmit data/frames to each other. As indicated in steps A3 and A4 and as previously explained, valid data frames 20 of a particular length and dummy contents and at an appropriate data rate are transmitted from the signal generator 130 to the DUT 60. The data frame 20 is received by the DUT 60 and an ACK 30 is sent back in reply if the data frame has been validly received. Of course, a count needs to be kept by the controller 140 of the total number of data frames 20 sent during the test.

As indicated by block A4, a count also needs to be kept of the number of ACKS received during the test. Valid acknowledgements 30 received by the signal receiver 120 are determined. Furthermore, pseudo-valid acknowledgements, which are acknowledgements validly sent by the device, but not validly received by the signal receiver must also be determined. Pseudo-valid ACKs may be either non-valid (i.e corrupted) ACKs received at the signal receiver, or ACKs that were validly sent by the device but not able to be decoded and determined to be ACKs at the signal receiver at all. The latter should also be determined by detecting signals that resemble ACKs, as described below. As indicated in block A5, the total number of ACKs sent by the device should be counted by counting the total number of valid and pseudo-valid ACKs up to a maximum of one ACK for each frame sent to signify a successfully received frame by the DUT 60. This is because the detection of more than one ACK 30 per frame could occur (for example, a valid ACK and a signal resembling an ACK), which would, of course, interfere with the results.

The ACK 30 responses do not have sequence/fragment numbers and therefore, in the case of a failed transaction (no valid ACK), it is not be possible to determine whether the data frame 20 or the ACK 30 was lost. However, the reception of an invalid or corrupted ACK 30 or even signal energy resembling an ACK 30 could be used as evidence that the sent data frame 20 was received correctly. A valid ACK has to be received during a specific slot in the “inter-frame space (IFS)” and also has to pass a cyclic redundancy check (CRC); in the case of IEEE 802.11, both terms are further detailed as a part of IEEE 802.11 specification.

After sending a (data) frame, there are several possible outcomes:
1. A valid ACK is received in the correct ACK slot (during the IFS period)
2. A corrupted ACK is received in the ACK slot (due to a failed CRC).
3. A signal is observed on the channel in the ACK slot which resembles an ACK(more details see below)
4. A signal is observed on the channel in the ACK slot which does not resemble an ACK
5. No discernable signal is received on the signal during the ACK slot.

Outcomes 1-3 should increment the number of ACKs 30 counted, whereas 4-5 should not. It is therefore only necessary to monitor, using the signal receiver 120, not just for valid ACKs, but also for invalid (corrupted) ACKs. If neither are received, then the system can monitor for an increase of energy on a channel in the ACK slot after a frame to indicate that an ACK was sent. The total number of ACKs received is therefore a sum of the number of valid ACKs received plus the number of pseudo-valid ACKs received, as determined by the controller 140 and signal receiver 120. A possible different embodiment would not bother to count the number of valid ACKs received, but only detect the number of ACK-resembling signals (since this would, of course, include all valid ACKs as well as the pseudo-valid ACKS).

Whether or not the test is finished and another frame is sent is determined, as indicated in block A6. If the test has finished, the FER needs to be calculated, as indicated by block A7. The FER is then given by:

FER=(frames_sent−ACKs_received)/frames_sent

that is, the total number of frames sent minus the total number of valid and pseudo-valid ACKs received, divided by the total number of frames_sent. The operational flow of the test apparatus then finishes at point “F”.

In order to detect signal energy that resembles an ACK, there are at least two other approaches that could be taken. One is to feed the signal into a spectrum analyzer tuned to the centre frequency of the WLAN channel being used. The spectrum analyzer can be configured to burst trigger on detection of signal energy. By measuring the time between the sending of a packet (from the signal generator) and the burst trigger, it can be ascertained whether an ACK has been sent.

However, another approach could be to use a logarithmic amplifier (log amp) to detect the RF pulses of the ACK frames. If the RF burst is used as the input to the log amp, the output will be a voltage pulse. This can be fed into a comparator to determine the presence or absence of the RF burst (or the amplitude of the RF burst can be determined by measuring the amplitude of the log amp output voltage). Normally a power level of 10-20 dB above the noise floor would be required to comfortably discern the RF pulse over the noise signal. Furthermore, the system must be “gated” so that the ACK detection circuit is only operational during the SIFS period which occurs just after transmission of a frame. The gating can take place at any appropriate point in the detection system—for example at the output of the comparator.

If this method were used, it would be preferable to first pass the RF burst through a bandpass filter to increase the signal to noise ratio. This filter might be tunable to the channel centre frequency and span a few MHz or could be centered in the 2.4 GHz 802.11 spectrum and have sufficient bandwidth to permit all channels to pass through. The resulting signal would feed the log amp, which in turn would feed into a voltage comparator that was biased according to the noise level used in the test environment and mindful of the needs for the signal to be 10-20 dB above the noise floor. The comparator would be used to drive a digital pulse counter to count the ACK frames.

It should be noted that the signal receiver 120 could also be used to monitor the wireless link (20, 30) to identify any so-called ‘collisions’ owing to simultaneous transmissions from the signal generator 130 and DUT 60. Such collisions should be excluded from the FER results, or the test should be repeated so that no such collisions occur. If the client station 70 uses Microsoft Windows 2000, it is advisable to disable/uninstall the higher protocol layers, such as the TCP/IP stack on the client station 70, in order to prevent the transmission of messages originating from the network-layer and above.

IEEE 802.11 Acknowledgement Control frames are stateless and do not have any sequence/fragment numbers. Therefore not receiving a valid ACK may mean that the sent frame, the ACK or both were lost/corrupted. This problem can be circumvented by recognising that it is only necessary to observe the increase in energy on a channel in the ACK slot after a frame to indicate that an ACK was sent. Various methods have been outlined of how this can be achieved. Observing the increase in energy is particularly useful, since it means that corrupted ACKs can also be counted.

The present invention also removes the need to depend on 3^{rd} party hardware to discern if an ACK was received, thus allowing a more transparent and scientific approach to the calculation of FER.

It should be clear to someone skilled in the art that all such additional embodiments are within the spirit and scope of the invention.

What we claim is:

1. A method for measuring the error rate of a communication device, the method comprising:
configuring a signal generator and the communication device to communicate;
transmitting a signal frame from the signal generator;
sending an acknowledgement from the communication device if the signal frame is correctly received by the communication device;
determining whether a valid or pseudo-valid acknowledgment has been sent by the communication device;
counting the number of valid and pseudo-valid acknowledgements; and
computing a frame error rate based on the total number of valid and pseudo-valid acknowledgements compared to the total number of signal frames transmitted.

2. The method of claim 1 wherein the device is a wireless device.

3. The method of claim 1, wherein the signal frame comprises pre-formatted data packets.

4. The method of claim 1, wherein determining whether a valid acknowledgement has been sent by the communication device comprises detecting whether a valid acknowledgement is received.

5. The method of claim 1, wherein determining whether a pseudo-valid acknowledgement has been sent by the communication device comprises detecting whether a corrupted acknowledgement is received.

6. The method of claim 1, wherein determining whether a pseudo-valid acknowledgement has been sent by the communication device comprises detecting whether a signal resembling an acknowledgement is detected during a time when an acknowledgement is expected.

7. The method of claim 1, wherein predetermined noise is also transmitted.

8. The method of claim 1, wherein at most one valid or pseudo-valid acknowledgement is counted for each frame transmitted by the signal generator.

9. The method of claim 6, wherein detecting whether a detected signal resembles an acknowledgement comprises determining whether the signal is detected on a channel used for acknowledgements.

10. A system for measuring the error rate of a communication device, the system comprising:
a signal generator for transmitting a signal frame to the communication device;
a controller coupled to said signal generator for controlling the signal generator;
wherein said controller determines whether a valid or pseudo-valid acknowledgment has been sent by the communication device; and
wherein said controller counts the number of valid and pseudo-valid acknowledgements and computes a frame error rate based on the total number of valid and pseudo-valid acknowledgements compared to the total number of signal frames transmitted.

11. The system of claim 10, wherein the device is a wireless device.

12. The system of claim 10, further comprising a signal receiver for receiving valid and pseudo-valid acknowledgements transmitted by the communication device if the signal frame is correctly received by the device.

13. The system of claim 12, wherein the controller, signal generator and signal receiver emulate an access point.

14. The system of claim 10, wherein the frame comprises data packets.

15. The system of claim 12, wherein the signal generator is coupled to a transmit antenna and the signal receiver is coupled to a receive antenna, the transmit and receive antennae and the communication device being isolated in an anechoic chamber or other appropriate RF-shielded test fixture.

16. The system of claim 10, wherein the controller counts at most one valid or pseudo-valid acknowledgement for each signal frame transmitted.

17. The system of claim 10, wherein noise is also transmitted by the signal generator.

18. The system of claim 12, wherein the controller determines whether a valid acknowledgement has been received by the signal receiver.

19. The system of claim 12, wherein the controller determines whether a corrupted acknowledgement has been received by the signal receiver.

20. The system of claim 15, wherein the receive antenna comprises a high sensitivity antenna.

21. The system of claim 20, further comprising a signal analyzer coupled to the high sensitivity antenna, for determining whether a signal resembling an acknowledgement is detected during a time when an acknowledgement is expected.

22. The system of claim 21, wherein the signal analyzer determines whether a detected signal resembles an acknowledgement by determining whether the signal is detected on a channel used for acknowledgements.

23. The system of claim 10, further comprising an authenticating module for originating and authenticating communication with the communication device.
